(19) United States
(12) Patent Application Publication
(10) Pub. No.: US 2008/0061534 A1
(43) Pub. Date: Mar. 13, 2008

(54) Folding device for strollers

(76) Inventor: Hung-Tsun Chen, Taichung County (TW)

Correspondence Address: Hung-Tsun Chen, P.O. Box 44 - 2049, Taipei, 10668, omitted

(21) Appl. No.: 11/518,270

(22) Filed: Sep. 11, 2006

(51) Int. Cl. B62B 7/06

(52) U.S. Cl. 280/647

(57) ABSTRACT

An X-shaped folding device of a baby stroller is connected between the front and rear wheel frames of the stroller and includes a pair of front rods pivotably connected to the front wheel frame and a pair of rear rods pivotably connected to the rear wheel frame. The rear rods are crossly and pivotably connected to the front rods. A link device is connected to the pivotable member on the pivotal point of the two rear rods. The X-shaped folding device is folded by lifting the link device to folding the baby stroller, and is unfolded by pressing the link device. The link device further locks the folding device to prevent folding of the X-shaped folding device.

### BACKGROUND OF THE INVENTION

(1) Field of the Invention

The present invention relates to a folding device for a baby stroller and the folding device can be locked within one action.

(2) Description of the Prior Art

A conventional baby stroller generally includes a front wheel frame with front wheels connected thereto and a rear wheel frame with rear wheels, and a V-shaped link device is connected between the front and rear wheel frames and the V-shaped link device can be folded in vertical direction so as to pull the front and rear wheel frames toward each other. Another folding device for a baby stroller includes an X-shaped link device which is connected between the front and rear wheel frames. The X-shaped link device can be folded in horizontal direction to fold the baby stroller. Both of the two types of conventional folding devices need a locking device which usually is not located with the folding device, so that the user has to remember to lock the locking device which is connected on the handle or on a side of the rear wheel frame. If the locking device is not locked, the folding device can be activated by any impact to the baby stroller and this could lead to an injury to the baby.

The present invention intends to provide a folding device for a baby stroller and the folding device is operated by operating a handle. The folding device is locked within one action so that the accident mentioned above can be effectively avoided.

### SUMMARY OF THE INVENTION

The present invention relates to a baby stroller that comprises a front wheel frame, a rear wheel frame, a handle frame, an X-shaped folding device and a link device. The front wheel frame has front wheels connected thereto and two connection members are connected to two respective top ends of the front wheel frame. The rear wheel frame with rear wheels connected thereto and two respective top ends of the rear wheel frame are pivotably connected to the connection members. The handle frame has two lower ends which are pivotably connected to the connection members. The X-shaped folding device is connected between the front and rear wheel frames, and includes a pair of front rods and each front rod has a first end pivotably connected with the front wheel frame. Two respective second ends of the first rods are pivotably connected to two respective first ends of a pair of rear rods. Two respective second ends of the rear rods are pivotably connected with the rear wheel frame. A pivotable member is connected on a top of a pivotal point of the two first ends of the rear rods. The link device is connected to the pivotable member so that the X-shaped folding device is folded by lifting the link device. The X-shaped folding device is unfolded by pressing the link device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the baby stroller of the present invention;

FIG. 2 is an exploded view to show the folding device and the link device of the baby stroller of the present invention;

FIG. 3 is a side view to show the baby stroller of the present invention;

FIG. 4 is a cross sectional view of the X-shaped folding device of the baby stroller of the present invention;

FIG. 5 shows the connection between the front rods and the rear rods of the baby stroller of the present invention;

FIG. 6 shows a part of the X-shaped folding device and the link device when the baby stroller is unfolded;

FIGS. 7 and 8 show two consecutive actions of lifting the handle of the baby stroller of the present invention;

FIG. 9 shows a side view of the baby stroller when the handle is lifted;

FIG. 10 shows that the handle is lifted to its high position to fold the baby stroller, and

FIG. 11 shows a side view to show the folded baby stroller.

### DETAILED DESCRIPTION OF THE PREFERRED EMBODIMENT

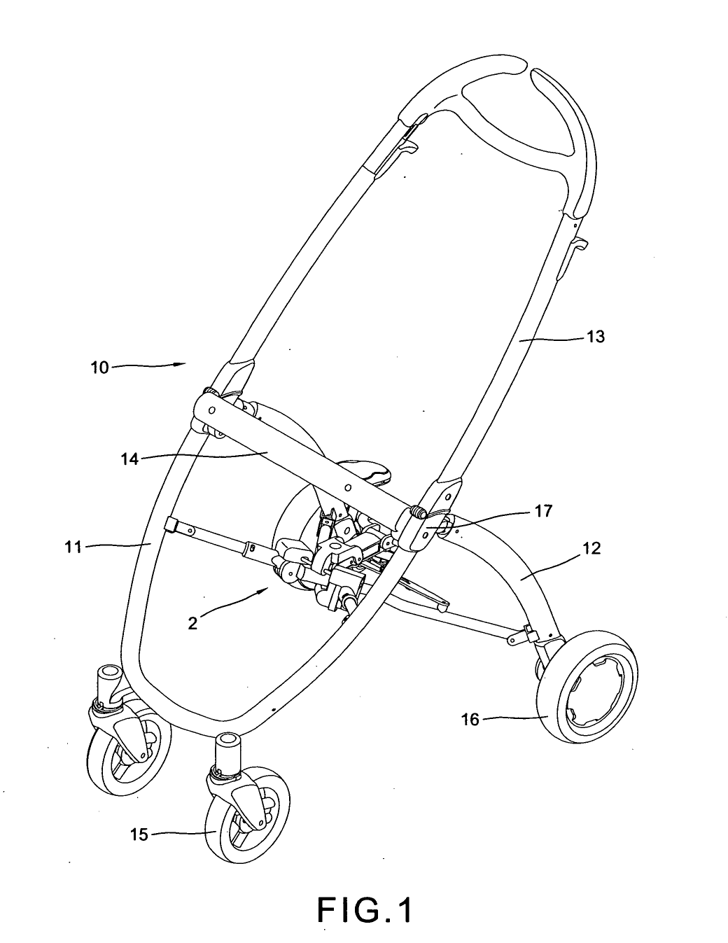

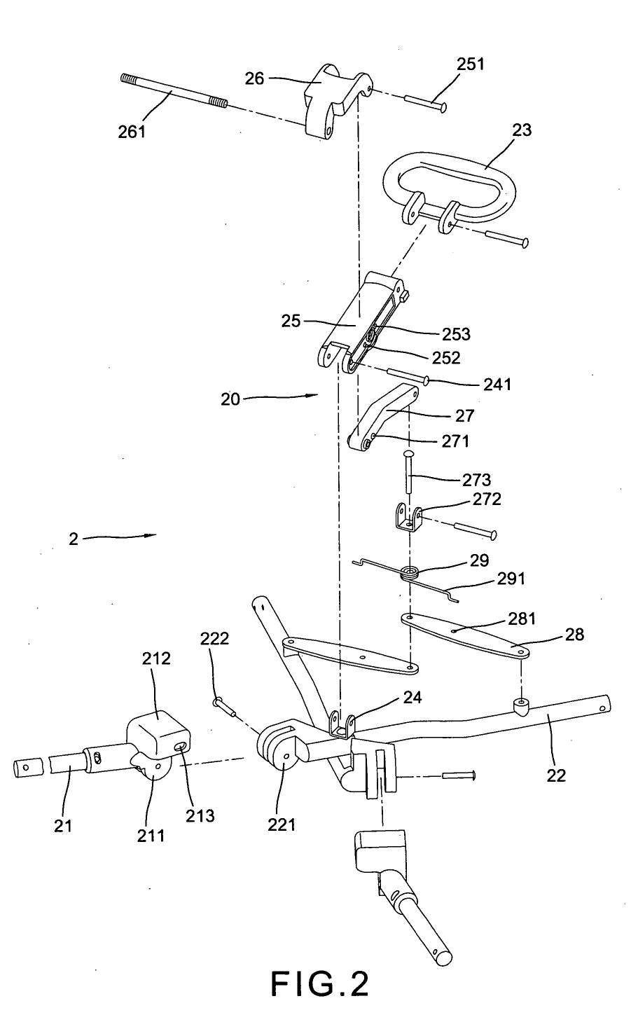

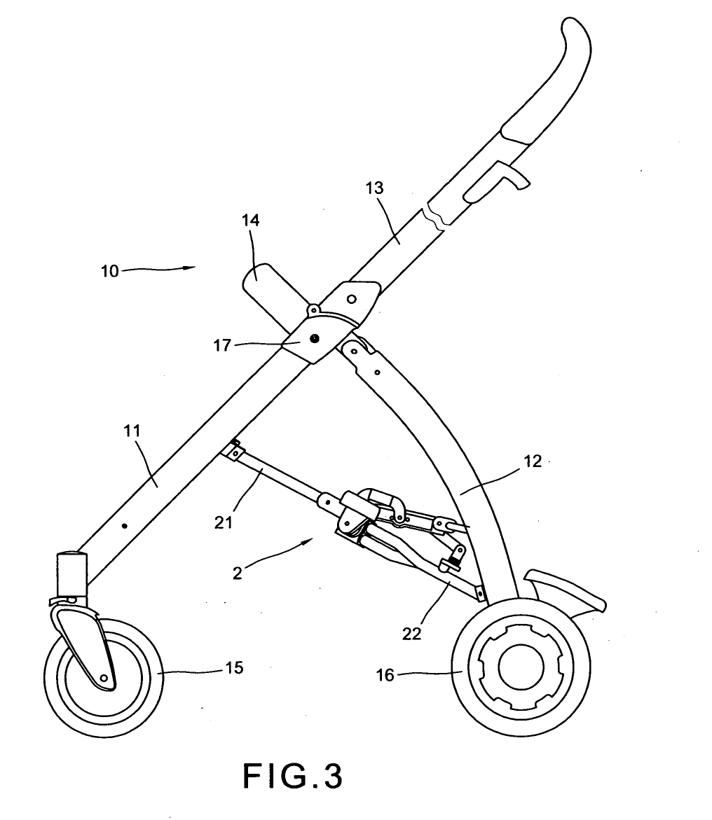

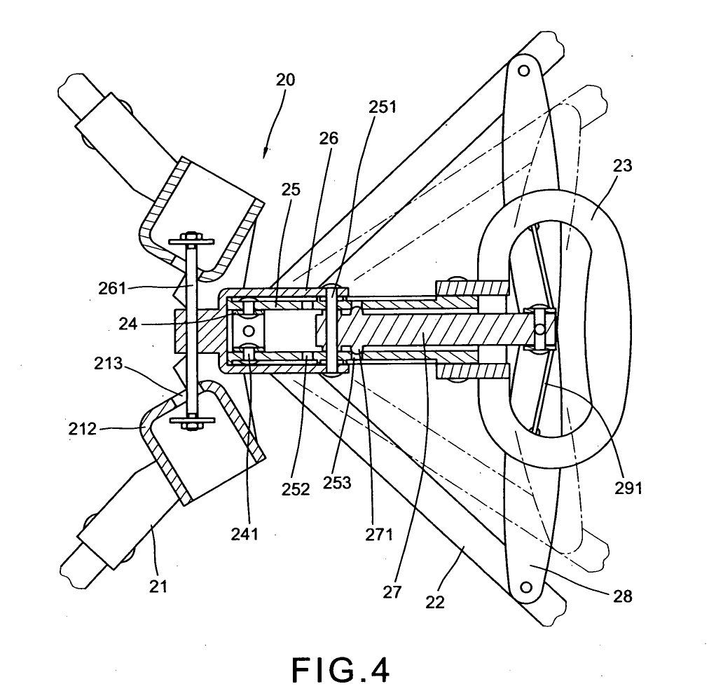

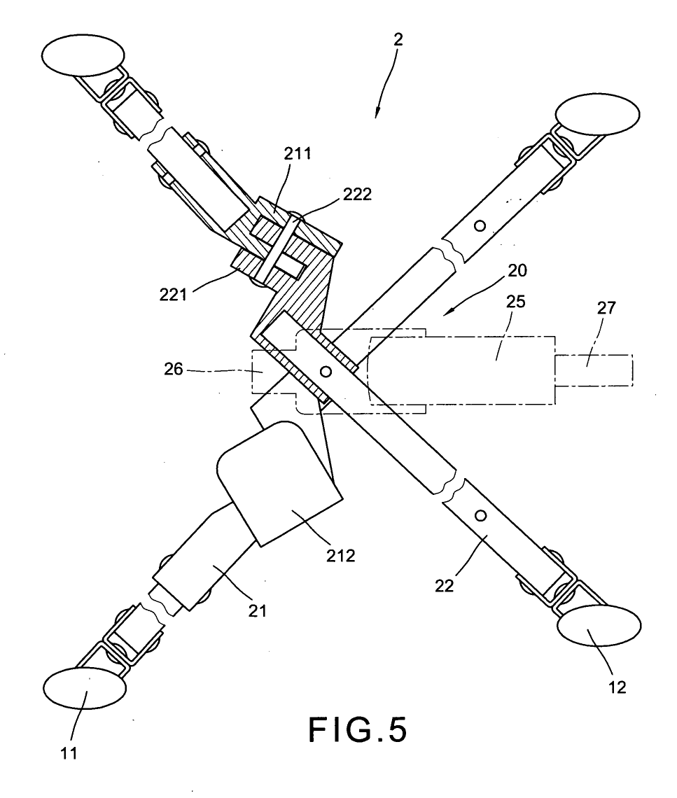

Referring to FIGS. 1 to 5, the baby stroller 10 of the present invention comprises a U-shaped front wheel frame 11 with two front wheels 15 connected thereto and two connection members 17 are connected to two respective top ends of the front wheel frame 11. A U-shaped rear wheel frame 12 has two rear wheels 16 connected thereto and two respective top ends of the rear wheel frame 12 are pivotably connected to the connection members 17. A U-shaped handle frame 13 has two lower ends which are pivotably connected to the connection members 17. A seat bar 14 is connected between the two respective top ends of the front wheel frame 11 so as to install a seat (not shown) thereon.

An X-shaped folding device 2 is connected between the front and rear wheel frames 11. The X-shaped folding device 2 includes a pair of front rods 21 and each front rod 21 has a first end pivotably connected with the front wheel frame 11. Two respective second ends of the front rods 21 are pivotably connected to two respective first ends of a pair of rear rods 22. Two respective second ends of the rear rods 22 are pivotably connected with the rear wheel frame 12. A first connection piece 211 is connected to the two respective second ends of the two front rods 21 and a second connection piece 221 is connected to the two respective first ends of the two rear rods 22. The first and second connection pieces 211, 221 are pivotably connected with each other by a pin 222. A pivotable member 24 is connected on a top of a pivotal point of the two first ends of the rear rods 22.

A link device 20 is connected to the pivotable member 24 and includes a main part 25, a first part 26, a second part 27, a pair of links 28 and a handle 23. The main part 25 has a first end pivotably connected to the pivotable member 24 of the rear rods 22 by a rive 241. The handle 23 is pivotably connected to a second end of the main part 25. A front end of the first part 26 is pivotably connected to the front rods 21 by a bar 261 and a second end of the first part 26 is pivotably connected to a mediate portion of the main part 25 by a rivet 251. Two boxes 212 are respectively connected to the two respective second ends of the front rods 21 and a passage 213 is defined through each of the boxes 212. The first end of the first part 26 is pivotably connected between the two boxes 212 by extending the bar 261 through the passage 213 and connected to the two boxes 212.

A first end of the second part 27 has two bosses 271 on two sides thereof and the two bosses 271 are movably engaged with one of a first hole 252 and a second hole 253 defined in the mediate portion of the main part 25. A U-shaped member 272 is pivotably connected to a second end of the second part 27 by a rivet 273. The two links 28 has two respective first ends pivotably connected with each other and two respective second ends of the two links 28 are pivotably connected to the two rear rods 22. A torsion spring 29 is connected between the U-shaped member 272 and one of the two links 28. The torsion spring 29 has two legs 291 which extend through two respective apertures 281 defined through the two links 28,

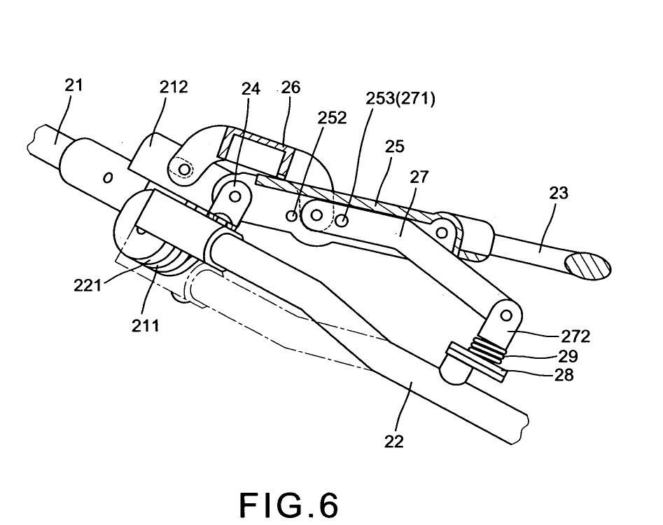

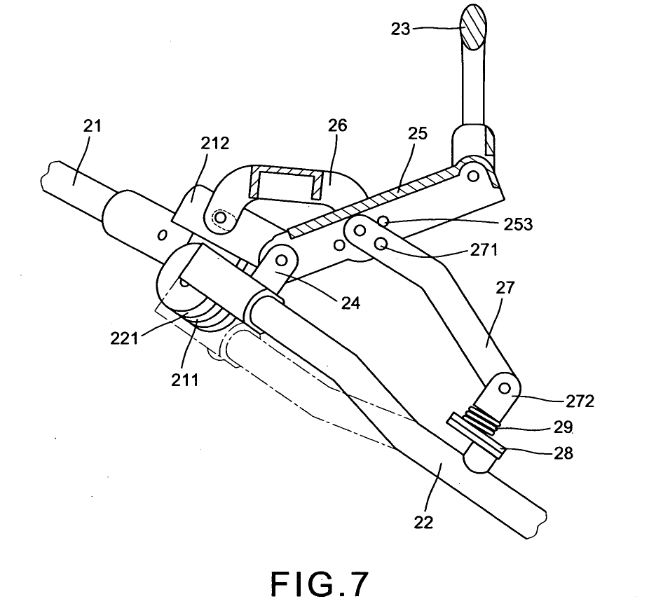

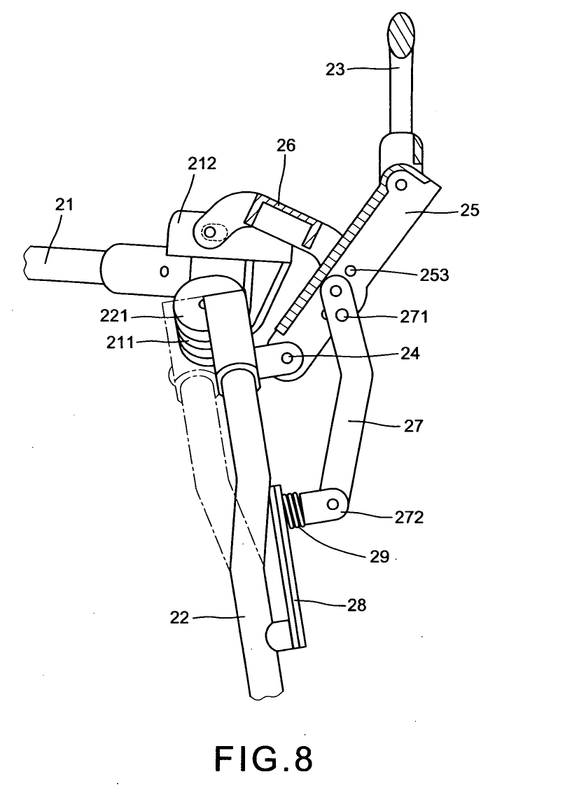

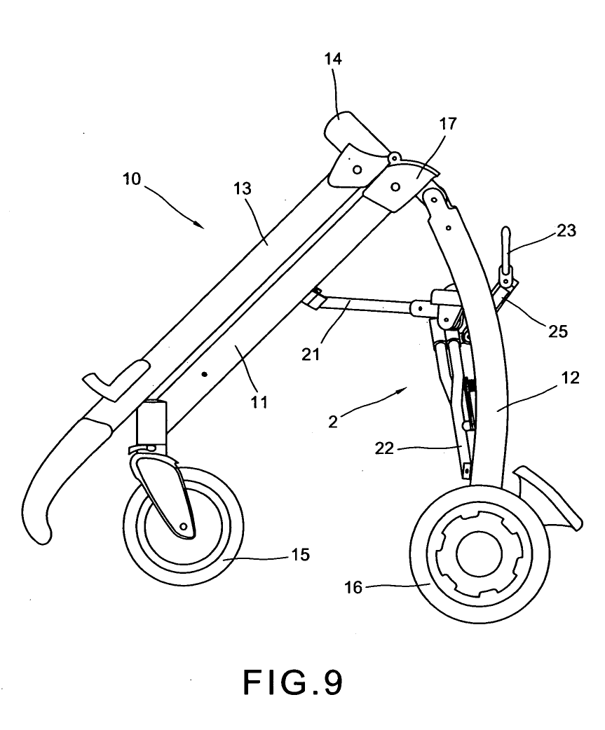

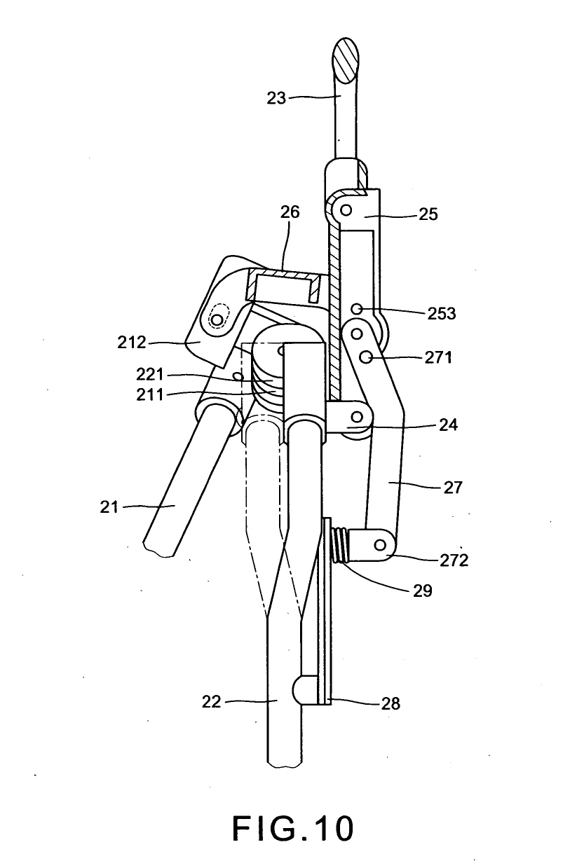

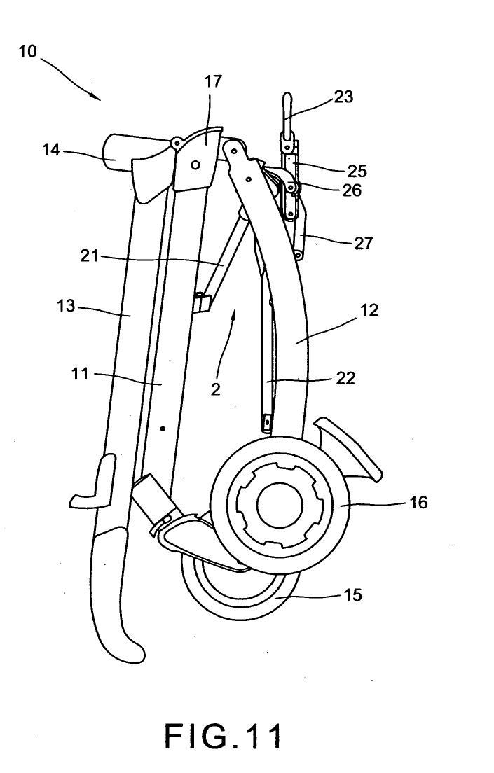

As shown in FIGS. 6 and 7, when lifting the handle 23 upward, the second end of the main part 25 is lifted so that the bosses 271 on the second part 27 are disengaged from the second holes 253 in the main part 25. The first and second parts 26, 27 are then activated relative to the pivotable member 24. The first part 26 moves forward and upward to pull the two links 28 and the front wheel frame 11 is moved backward and the rear wheel frame 12 is moved forward. When the handle 23 is further lifted upward as shown in FIG. 8, the front rods 21 and the rear rods 22 are lifted upward. The front wheel frame 11 and the rear wheel frame 12 are moved toward each other, the handle frame 13 is pivoted downward to be closed to the front wheel frame as shown in FIG. 9. The user then push the front wheel frame 11 and the rear wheel frame 12 together as shown in FIGS. 10 and 11, the main part 25 is pivoted to its extreme position, the first holes 252 of the main part 25 are engaged with the bosses 271 of the first part 26, so that the main part 25 and the first part 26 are secured so as to completely fold the baby stroller 10.

When unfolding the baby stroller 10, the handle 23 is pushed downward, the first holes 252 are disengaged from the bosses 271, and the handle 23 is continuously pushed downward to press the main part 25 which activates the first and second parts 26, 27 to expand the front rods 21 and the rear rods 22. The front wheel frame 11 and the rear wheel frame 12 are then expanded. The main part 25 is pressed to its another extreme position to allow the front and rear rods 21, 22 to expand as an X-shape. The second holes 253 are again engaged with the bosses 271 so that the main part 25 and the second part 27 are secured so that the folding device 2 is not folded.

The torsion spring 29 provide an reaction force to the second part 27 so that when the main part 25 is pressed, the torsion spring 29 provides a space to allow the front and rear rods 21, 22 to be expanded to an X-shaped structure.

The folding device 2 can be folded by lifting the link device 20 and the X-shaped folding device 2 is locked by the link device 20. The locking action is completed within one operation action.

While we have shown and described the embodiment in accordance with the present invention, it should be clear to those skilled in the art that further embodiments may be made without departing from the scope of the present invention.

1. A baby stroller comprising:
a front wheel frame having front wheels connected thereto and two connection members connected to two respective top ends of the front wheel frame;
a rear wheel frame with rear wheels connected thereto and two respective top ends of the rear wheel frame pivotably connected to the connection members;
a handle frame having two lower ends which are pivotably connected to the connection members;
an X-shaped folding device connected between the front and rear wheel frames, the X-shaped folding device including a pair of front rods and each front rod having a first end pivotably connected with the front wheel frame, two respective second ends of the front rods pivotably connected to two respective first ends of a pair of rear rods, two respective second ends of the rear rods pivotably connected with the rear wheel frame, a pivotable member connected on a top of a pivotal point of the two first ends of the rear rods, and
a link device connected to the pivotable member, the X-shaped folding device being folded by lifting the link device, the X-shaped folding device being unfolded by pressing the link device.

2. The stroller as claimed in claim 1, wherein the link device includes a main part, a first part, a second part, a pair of links and a handle, the main part has a first end pivotably connected to the pivotable member of the rear rods, the handle is pivotably connected to a second end of the main part, a front end of the first part is pivotably connected to the front rods by a bar and a second end of the first part is pivotably connected to a mediate portion of the main part, a first end of the second part has two bosses on two sides thereof and the two bosses are movably engaged with one of a first hole and a second hole defined in the mediate portion of the main part, a U-shaped member is pivotably connected to a second end of the second part, the two links have two respective first ends pivotably connected with each other and two respective second ends of the two links are pivotably connected to the two rear rods, a torsion spring is connected between the U-shaped member and one of the two links, the torsion spring has two legs which extend through two respective apertures defined through the two links.

3. The stroller as claimed in claim 1, wherein a first connection piece is connected to the two respective second ends of the two front rods and a second connection piece is connected to the two respective first ends of the two rear rods, the first and second connection pieces are pivotably connected with each other by a pin.

4. The stroller as claimed in claim 2, wherein two boxes are respectively connected to the two respective second ends of the front rods and a passage is defined through each of the boxes, the first end of the first part is pivotably connected between the two boxes by extending the bar through the passage and connecting to the two boxes.
